(19) United States
(12) Patent Application Publication
(10) Pub. No.: US 2019/0301352 A1
(43) Pub. Date: Oct. 3, 2019

(54) Method and Apparatus for Charge Air Control

(71) Applicant: Air Cycle Technology Limited, Hove, East Sussex (GB)

(72) Inventors: Christopher David WHELAN, Ansty, West Sussex (GB); Stephen Norman HINTON, Eastbourne, East Sussex (GB)

(73) Assignee: Air Cycle Technology Limited, Hove, East Sussex (GB)

(21) Appl. No.: 16/307,236

(22) PCT Filed: Jun. 8, 2017
(86) PCT No.: PCT/GB2017/051671

§ 371 Date: Dec. 5, 2018

(30) Foreign Application Priority Data
Jun. 9, 2016 (GB) 1610087.7

(51) Int. Cl. F02B 29/04

(52) U.S. Cl. CPC F02B 29/0425; F02B 29/0481; F02B 29/0493; F02B 29/0437; F02B 29/0412

(57) ABSTRACT

A charge air control system for a forced induction internal combustion engine, comprising sensing means, comparison means and temperature control means. The sensing means are arranged to measure one or more attributes of charge air proximal to an air inlet of the internal combustion engine. The comparison means are arranged to compare the one or more attributes of charge air to at least one predetermined value. The temperature control means are arranged to control the temperature of the charge air in dependence on the comparison means.

This invention relates to a method and apparatus for controlling inlet charge air for a forced induction internal combustion engine.

### BACKGROUND

Market pressure within the automotive industry is leading engine manufacturers to downsize engines whilst increasing the specific power which an engine can deliver (hp/litre). With an increase in specific power, the performance and fuel economy of the engine is compromised by the onset of knock. Knock is a phenomenon in which fuel combusts outside of the envelope of the normal combustion front set off by a spark plug. Knocking can be relatively inconsequential to the engine or it can be uncontrollably destructive to the engine.

It is well known that reducing engine intake air temperature at constant density reduces the combustion knock tendency. In a forced induction internal combustion engine, a turbocharger is used to “charge” the air prior to the engine intake. This results in charge air at a higher temperature, pressure and density than ambient air, which forces more air into the engine intake. Typically, a charge air cooler is positioned at the outlet of the turbocharger to cool the charge air whilst maintaining the density, thus reducing combustion knock tendency.

It is also known that a turbo-expander may be used to further reduce charge air temperature, at constant density, prior to the engine intake. A turbo-expander includes a compressor and a turbine, in which charge air is expanded through the turbine to drive the compressor. Typically, a charge air cooler may be positioned between the compressor and the turbine to further reduce charge air temperature using a gas or liquid. The intention of the turbo-expander is that charge air density is relatively unchanged between inlet and outlet of the turbo-expander, whilst cooling and expansion of the charge air significantly reduces the charge air temperature. Certain prior art systems as described above have no means to control the charge air temperature within such a system, rather, they operate independent of any such control. As a result, charge air with an undesirable temperature may be provided to the engine intake. Further, such a cooling system as described above may disadvantageously effect engine operation in cold start conditions.

It is desirable to have a charge air cooling system which can accurately control charge air temperature over a wide range of ambient temperatures. Further, it is desirable to have a charge air system in which a higher charge air temperature may be provided in circumstances whereby the ambient temperature is significantly low relative to the normal operating temperature of the engine.

It is an object of certain embodiments of the present invention to address the above-described disadvantages associated with the prior art.

### BRIEF SUMMARY OF THE DISCLOSURE

According to aspects of the present invention, there is provided apparatus and methods as set forth in the appended claims.

According to an aspect of the invention, there is provided a charge air control system for a forced induction internal combustion engine, comprising:

one or more sensing devices arranged to measure one or more attributes of charge air proximal to an air inlet of the internal combustion engine and to output a signal indication thereof;

a comparison unit arranged to receive the signal indicative of the one or more attributes and to compare the one or more attributes of charge air to at least one predetermined value; and

temperature control apparatus arranged to control the temperature of the charge air in dependence on the comparison performed by the comparison unit.

In certain embodiments, the temperature control means may include a turbo-expander having a turbine driving a compressor, configured such that, in use, charge air may be compressed in the compressor and expanded in the turbine, and the turbine outlet is in fluid communication with the air inlet of the internal combustion engine.

In certain embodiments, the temperature control means may include at least one heat exchanger configured to transfer heat between the charge air and a control fluid of the heat exchanger. The at least one heat exchanger may comprise a first heat exchanger positioned between the compressor of the turbo-expander and the turbine of the turbo-expander. The first heat exchanger may include a first transfer fluid configured to extract heat from charge air passing therethrough. The first heat exchanger may include a second transfer fluid configured to transfer heat to charge air passing therethrough. The at least one heat exchanger may comprise a second heat exchanger positioned upstream of the compressor of the turbo-expander. The at least one heat exchanger may be a charge air cooler.

In certain embodiments, the temperature control means may include one or more ducts having a valve configured to redirect charge air when the valve is switched between a closed and an open position. The one or more ducts may include a recirculation duct having a recirculation valve configured to recirculate charge air from an outlet of the compressor of the turbo-expander, to an inlet of the compressor of the turbo-expander. The one or more ducts may include a first bypass duct having a first bypass valve configured for charge air to bypass the turbine of the turbo-expander. The one or more ducts may include a second bypass duct having a second bypass valve configured for charge air to bypass the first heat exchanger. The one or more ducts may include a third bypass duct having a third bypass valve configured for charge air to bypass the turbo-expander. The one or more ducts may include a fourth bypass duct having a fourth bypass valve configured for charge air to bypass the second heat exchanger and the turbo-expander.

In certain embodiments, the temperature control means may further include a control unit configured to receive data relating to an output from the comparison means. The control unit may be further configured to control the operation of the valve of the one or more ducts in dependence on the output from the comparison means. The control unit may be further configured to determine which of the first or second transfer fluids to circulate within the first heat exchanger in dependence on the output from the comparison means.

In certain embodiments, the turbine of the turbo-expander may include variable angle stator vanes. The control unit of the temperature control means may be further configured to control the angle of the variable angle stator vanes in dependence on the output from the comparison means.

In certain embodiments, the sensing means may include a temperature sensor.

In certain embodiments, the sensing means may include a humidity sensor.

According to a further aspect of the invention, there is provided a method of controlling the temperature of charge air within a forced induction internal combustion engine, the method comprising:

measuring one or more attributes of charge air proximal to an air inlet of the forced induction internal combustion engine;

comparing each of the one or more measured attributes to at least one predetermined value; and

controlling the temperature of charge air based on a result of the comparison.

In certain embodiments, the measuring may comprise measuring the temperature of the charge air.

In certain embodiments, the measuring may comprise measuring the humidity of the charge air.

In certain embodiments, the predetermined value is calculated based on one or more parameters including engine speed, engine load, engine coolant temperature, and ambient conditions. The predetermined value may be a target temperature for charge air prior to intake.

In certain embodiments, the forced induction internal combustion engine may comprise a turbocharger, a turbo-expander having a first heat exchanger positioned between the compressor of the turbo-expander and the turbine of the turbo-expander, and a second heat exchanger position between the turbocharger and the turbo-expander. The step of controlling may comprise bypassing charge air around the second heat exchanger. The step of controlling may comprise bypassing charge air around the turbo-expander. The step of controlling may comprise recirculating charge air from an outlet of the compressor of the turbo-expander to an inlet of the compressor of the turbo-expander. The step of controlling may comprise bypassing charge air around the first heat exchanger. The step of controlling may comprise bypassing charge air around the turbine of the turbo-expander.

In certain embodiments, the turbine of the turbo-expander may comprise variable angle stator vanes, and the step of controlling may comprise controlling the angle of the variable angle stator vanes.

According to another aspect of the invention, there is provided a charge air control system for a forced induction internal combustion engine, comprising:

one or more sensing devices arranged to measure one or more attributes of charge air proximal to an air inlet of the internal combustion engine and to output a signal indication thereof;

a comparison unit arranged to receive the signal indicative of the one or more attributes and to compare the one or more attributes of charge air to at least one predetermined value; and

temperature control apparatus arranged to control the temperature of the charge air in dependence on the comparison performed by the comparison unit.

### BRIEF DESCRIPTION OF THE DRAWINGS

Embodiments of the invention are further described hereinafter with reference to the accompanying drawings, in which:

FIG. 1 is a schematic flow diagram of a forced induction internal combustion engine having a charge air control system in accordance with an embodiment of the present invention.

FIGS. 2 to 6 are plots showing charge air temperature against engine speed for the charge air control system of FIG. 1 in different operating modes; and

FIG. 7 is a plot showing the position of valves of the charge air control system of FIG. 1 when operating in the modes shown in FIGS. 2 to 6.

### DETAILED DESCRIPTION

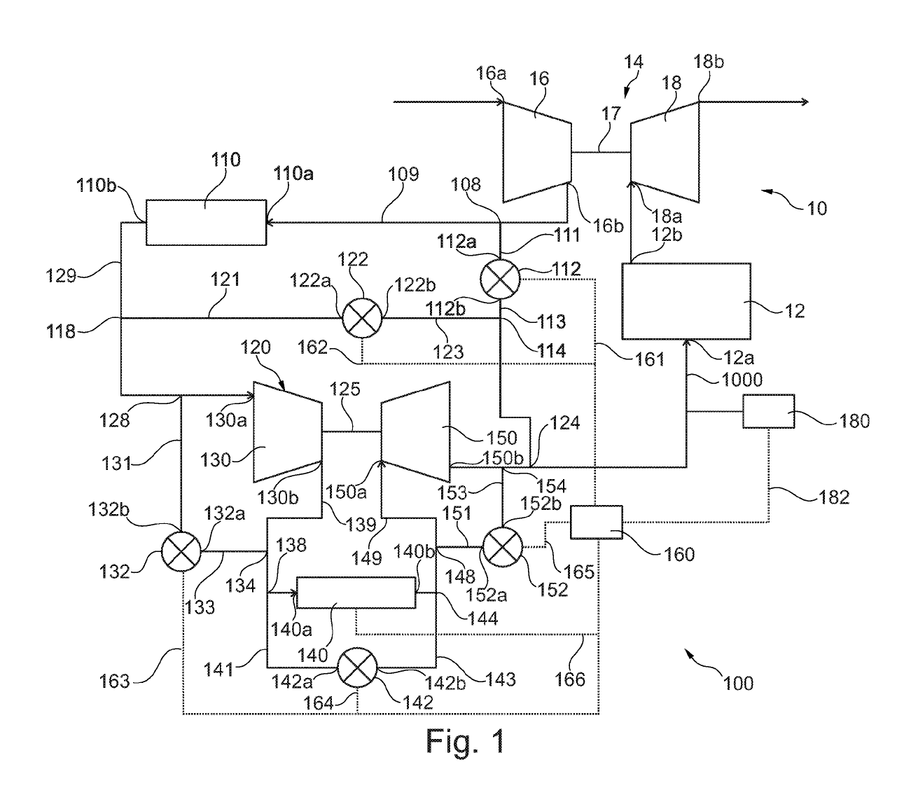

A forced induction internal combustion engine 10 having a charge air control system 100 in accordance with an embodiment of the present invention is shown schematically in FIG. 1. The forced induction internal combustion engine 10 includes an internal combustion engine 12 having an air inlet 12a and an exhaust 12b, a turbocharger 14 having a first compressor 16 rotatably coupled to and driven by a first turbine 18 via a first shaft 17, a first charge air cooler 110, and an intake manifold 1000 coupled to the air inlet 12a.

The charge air control system 100 includes a turbo-expander 120 having a second compressor 130 rotatably coupled to and driven by a second turbine 150 via a second shaft 125, a second charge air cooler 140, a control unit 160, a temperature sensor 180, a pre-cooler bypass valve 112, a turbo-expander bypass valve 122, a compressor recirculation valve 132, a cooler bypass valve 142 and a turbine bypass valve 152.

The first turbine 18 has an inlet 18a and an outlet 18b, the inlet 18a is coupled to the exhaust 12b of the internal combustion engine 12 and the outlet 18b leads to an exhaust pipe (not shown). The first compressor 16 has an inlet 16a open to the atmosphere.

The first compressor 16 includes an outlet 16b coupled to an inlet 110a of the first charge air cooler 110 by a first duct 109. The first duct 109 includes a pre-cooler bypass junction 108 positioned between the outlet 16b of the first compressor 16 and first charge air cooler inlet 110a. An inlet 112a of the pre-cooler bypass valve 112 is coupled to the pre-cooler bypass junction 108 by a first pre-cooler bypass duct 111. The pre-cooler bypass valve 112 includes an outlet 112b coupled to an intake junction 124 of the intake manifold 1000 via a second pre-cooler bypass duct 113. The second pre-cooler bypass duct 113 includes a bypass mixing junction 114 positioned between the pre-cooler bypass valve outlet 112b and the intake junction 124 of the intake manifold 1000.

The first charge air cooler 110 includes an outlet 110b coupled to an inlet 130a of the second compressor 130 by a second duct 129. The second duct 129 includes a turbo-expander bypass junction 118 positioned between the first charge air cooler outlet 110b and the second compressor inlet 130a. An inlet 122a of the turbo-expander bypass valve 122 is coupled to the turbo-expander bypass junction 118 by a first turbo-expander duct 121. The turbo-expander bypass valve 122 includes an outlet 122b coupled to the bypass mixing junction 114 of the second pre-cooler bypass duct 113 by a second turbo-expander bypass duct 123.

The second compressor 130 includes an outlet 130b coupled to an inlet 140a of the second charge air cooler 140 by a third duct 139. The third duct 139 includes a first compressor recirculation junction 134 positioned between the second compressor outlet 130b and the second charge air cooler inlet 140a. The compressor recirculation valve 132 includes an inlet 132a coupled to the first compressor recirculation junction 134 by a first compressor recirculation duct 133. The second duct 129 further includes a second compressor recirculation junction 128 positioned between the turbo-expander bypass junction 118 and the second compressor inlet 130a. The compressor recirculation valve 132 further includes an outlet 132b coupled to the second compressor recirculation junction 128 by a second compressor recirculation duct 131.

The third duct 139 further includes a first cooler bypass junction 138 positioned between the first compressor recirculation junction 134 and the second charge air cooler inlet 140a. An inlet 142a of the cooler bypass valve 142 is coupled to the first cooler bypass junction 138 by a first cooler bypass duct 141.

The second charge air cooler 140 includes an outlet 140b coupled to an inlet 150a of the second turbine 150 by a fourth duct 149. The fourth duct 149 includes a second cooler bypass junction 144 positioned between the second charge air cooler outlet 140b and the second turbine inlet 150a. The cooler bypass valve 142 includes an outlet 142b coupled to the second cooler bypass junction 144 by a second cooler bypass duct 143.

The fourth duct 149 further includes a first turbine bypass junction 148 positioned between the second cooler bypass junction 144 and the second turbine inlet 150a. An inlet 152a of the turbine bypass valve 152 is coupled to the first turbine bypass junction 148 by a first turbine bypass duct 151.

The second turbine 150 includes an outlet 150b coupled to the intake manifold 1000. The intake manifold 1000 includes a second turbine bypass junction 154 positioned between the outlet 150b of the second turbine 150 and the air inlet 12a of the forced induction internal combustion engine 10. The turbine bypass valve 152 includes an outlet 152b coupled to the second turbine bypass junction 154 by a second turbine bypass duct 153.

The intake junction 124 of the intake manifold 1000 is positioned between the second turbine bypass junction 154 and the inlet 12a of the forced induction internal combustion engine 10.

The temperature sensor 180 is coupled to the intake manifold 1000 at a position between the intake junction 124 and the inlet 12a of the forced induction internal combustion engine. The control unit 160 is coupled to the temperature sensor 180 by a sensor control path 182.

In FIG. 1, dotted lines indicate signal paths between components. The signal path between components may be either a simplex (one-way) or duplex (two-way e.g. feedback) signal. The signal path may be either a wired or wireless connection.

The control unit 160 includes a first control loop 161 connected to the pre-cooler bypass valve 112, a second control loop 162 connected to the turbo-expander bypass valve 122, a third control loop 163 connected to the compressor recirculation valve 132, a fourth control loop 164 connected to the cooler bypass valve 142, a fifth control loop 165 connected to the turbine bypass valve 152, and a sixth control loop 166 connected to the second charge air cooler 140. The control unit 160 receives a measured temperature from the temperature sensor 180 via a sensor control loop 182. The control unit 160 is configured to instruct the above mentioned valves to switch between a closed position, a partially open position, and an open position dependent on a comparison of the measured temperature and a predefined value. The control unit 160 is further configured to instruct the second charge air cooler 140 to switch between using a cooling transfer fluid, for cooling charge air, and a heating transfer fluid, for heating charge air, dependent on a comparison of the measured temperature to a predefined value.

During operation of the forced induction internal combustion engine 10, exhaust gas exits the engine 12 through the exhaust 12b and enters the first turbine 18 via the first turbine inlet 18a. The exhaust gas expands through the first turbine 18 which drives the first turbine 18 and, via the first shaft 17, the first compressor 16. Then the exhaust gas exits to atmosphere via the first turbine outlet 18b. Ambient air enters the first compressor 16 via the first compressor inlet 16a and is compressed by the first compressor 16. Charge air, with an increased density relative to the ambient air, then exits the first compressor outlet 16b and into the first duct 109.

An example of air flow through the charge air control system 100 with all valves closed will now be described.

With the pre-cooler bypass valve 112 closed, the charge air then flows from the first duct 109 into the first charge air cooler inlet 110a. As charge air passes through the first charge air cooler 110, heat is extracted from the charged air using ambient air or a liquid as a transfer fluid. The charge air then exits through the first charge air cooler outlet 110b into the second duct 129.

With the turbo-expander bypass valve 122 and the compressor recirculation valve 132 both closed, the charge air flows from the second duct 129 into the second compressor 130 via the second compressor inlet 130a. The second compressor 130 compresses the charge air which then exits through the second compressor outlet 130b into the third duct 139.

With the cooler bypass valve 142 closed, the charge air then flows from the third duct 139 into the second charge air cooler 140 via the second charge air cooler inlet 140a. As the charge air passes through the second charge air cooler 140, heat is extracted from the charge air using a cooling transfer fluid of the second charge air cooler 140. The charge air then exits through the second charge air cooler outlet 140b into the fourth duct 149.

With the turbine bypass valve 152 closed, the charge air then flows from the fourth duct 149 into the second turbine 150 via a second turbine inlet 150a. The charge air expands through the second turbine 150 which drives the second turbine 150 and, via the second shaft 125, the second compressor 130. The charge air then exits through the second turbine outlet 150b into the intake manifold 1000. The charge air then passes through the temperature sensor 180 before entering the engine 12 via the air inlet 12a.

The temperature sensor 180 measure the temperature of the charge air prior to the air inlet 12a, and transmits data relating to this measurement to the control unit 160 via the sensor control path 182. The control unit 160 compare the data relating to the temperature measurement against predetermined values.

In certain embodiments, the predetermined values may be optimum operating temperatures for charge air through the inlet 12a of the engine 12. The optimum operating temperatures may be dependent on parameters which influence the most efficient operation of the engine. The parameters may include engine speed, engine load, engine coolant temperature, and ambient conditions. Typically, the predetermined values are defined by algorithms or by mapped tables of values within a main engine control unit. The predetermined values may be developed by an engine manufacturer during engine calibration and vehicle development.

Based on the comparison of the predetermined temperature data with the measured temperature data, the control unit 160 may determine whether to open or partially open any of the valves within the charge air control system 100.

In certain embodiments, the charge air control system 100 may include one, some, or all of the valves described above with their corresponding ducts and junctions.

In certain embodiments, the second turbine 150 of the charge air control system 100 may comprise a row of stator vanes with a controllable angle configured to control the flow capacity of the second turbine 150. In certain embodiments, based on the comparison of the predetermined temperature data with the measured temperature data, the control unit 160 may determine whether to increase or decrease the flow capacity of the second turbine 150. Indeed, by controlling the flow capacity of the second turbine 150, the temperature drop across the second turbine 150 may be controlled. The flow capacity of the second turbine 150 may be controlled in conjunction with, or independent of, control of the one or more valves.

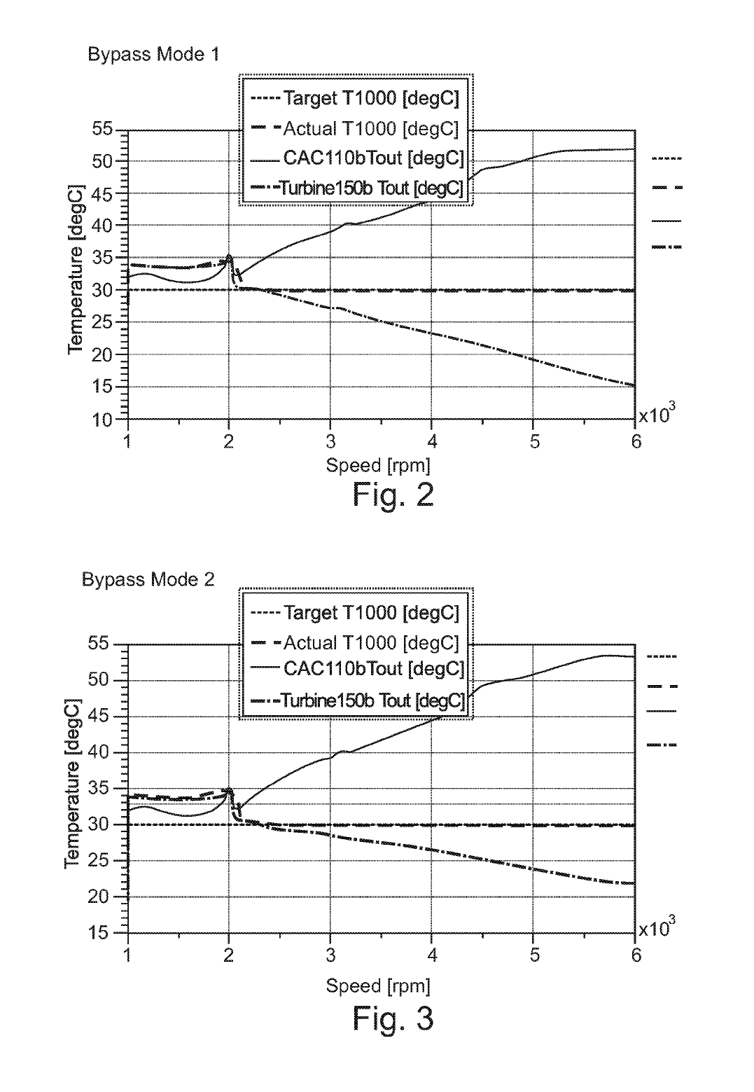

Example operating modes of the charge air control system 100 will now be described. The applicant has set up a simulation to model charge air temperature against engine speed for each operating mode, and simulated plots for each operating mode are shown in FIGS. 2 to 6 respectively. FIG. 7 indicates how each valve may open dependent on the engine operating speed for the plots of FIGS. 2 to 6.

In a first bypass mode, the control system 160 sends a signal via the first control loop 161 instructing the pre-cooler bypass valve 112 to switch from a closed position to an open position. With the pre-cooler bypass valve 112 open, charge air flows from the first compressor outlet 16b through the first duct 109, the first pre-cooler bypass duct 111, the pre-cooler bypass valve 112, and the second pre-cooler bypass duct 113, into the intake manifold 1000 via the intake junction 124. At the intake junction 124, the charge air from the second pre-cooler bypass duct 113 may mix with charge air from the second turbine outlet 150b before entering the air inlet 12a.

FIG. 2 shows a simulated plot of a possible relationship between charge air temperature and engine speed for a forced induction internal combustion engine including the charge air control system 100 operating the first bypass mode. As the measured charge air temperature in the intake manifold 1000 drops below the target temperature, the control unit 160 may instruct the pre-cooler bypass valve 112 to open. Subsequently, at intake junction 124, warmer charge air exiting the first compressor outlet 16b may mix with cooler charge air exiting the second turbine outlet 150b. Consequently, the temperature of the charge air in the intake manifold 1000 may be controlled to meet the target optimum operating temperature.

In a second bypass mode, the control system 160 sends a signal via the second control loop 162 instructing the turbo-expander bypass valve 122 to switch from a closed position to an open position. With the turbo-expander bypass valve 122 open, charge air flows from the first charge air cooler outlet 110b through the second duct 129, the first turbo-expander bypass duct 121, the turbo-expander bypass valve 122, the second turbo-expander bypass duct 123, and the second pre-cooler bypass duct 113, into the intake manifold 1000 via the intake junction 124. At the intake junction 124, the charge air from the second pre-cooler bypass duct 113 may mix with charge air from the second turbine outlet 150b before entering the air inlet 12a.

FIG. 3 shows a simulated plot of a possible relationship between charge air temperature and engine speed for a forced induction internal combustion engine including the charge air control system 100 operating the second bypass mode. As the measured charge air temperature in the intake manifold 1000 drops below the target temperature, the control unit 160 may instruct the turbo-expander bypass valve 122 to open. Subsequently, at intake junction 124, warmer charge air exiting the first charge air cooler outlet 110b may mix with cooler charge air exiting the second turbine outlet 150b. Consequently, the temperature of the charge air in the intake manifold 1000 may be controlled to meet the target optimum operating temperature.

In a third recirculation mode, the control system 160 sends a signal via the third control loop 163 instructing the compressor recirculation valve 132 to switch from a closed position to an open position. With the compressor recirculation valve 132 open, charge air flows from the second compressor outlet 130b through the third duct 139, the first compressor recirculation duct 133, the compressor recirculation valve 132, and the second compressor recirculation duct 131, into the second duct 129 via the second compressor recirculation junction 128. At the second compressor recirculation junction 128, the pressurised charge air from the second compressor recirculation duct 131 may mix with uncompressed charge air from the first charge air cooler outlet 110b before entering the second compressor inlet 130a. Consequently, this helps the second compressor 130 avoid going into surge in the event of a rapid drop of pressure in the system prior to the second compressor 130.

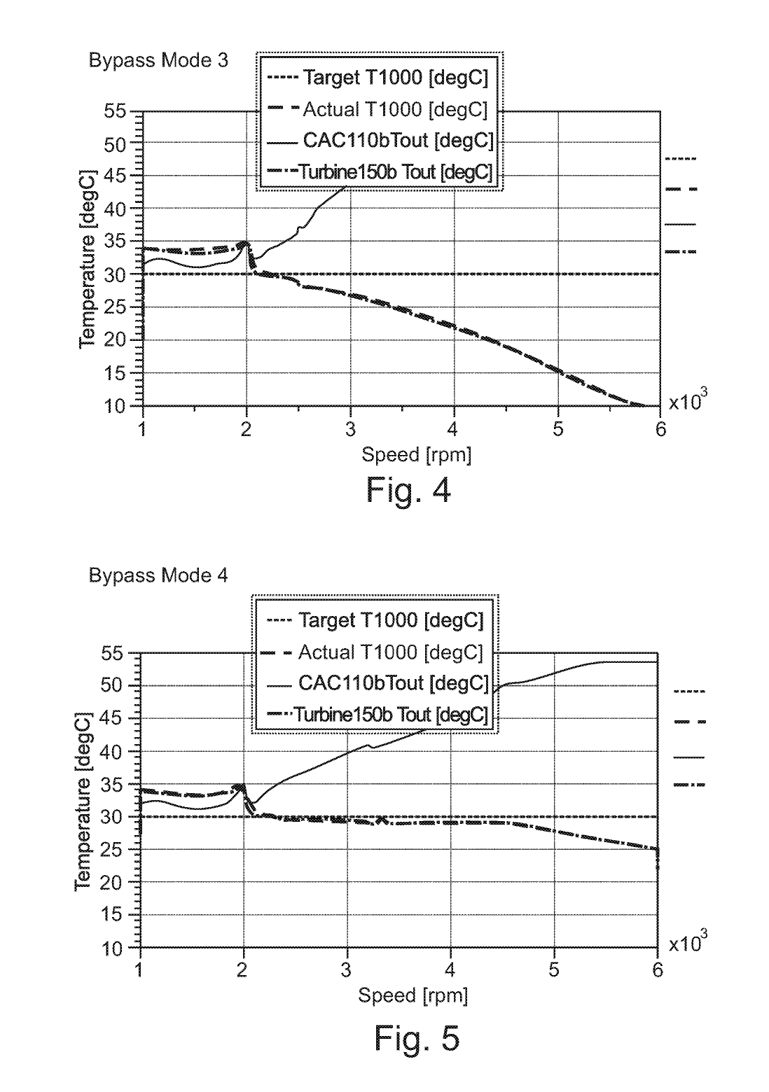

FIG. 4 shows a simulated plot of a possible relationship between charge air temperature and engine speed for a forced induction internal combustion engine including the charge air control system 100 operating the third recirculation mode. As discussed above, the purpose of recirculation valve 132 is to protect the second compressor 130 from possible surge. Thus, opening of the recirculation valve 132 in the plot shown in FIG. 5 may not have an effect on the measured charge air temperature.

In a fourth bypass mode, the control system 160 sends a signal via the fourth control loop 164 instructing the cooler bypass valve 142 to switch from a closed position to an open position. With the cooler bypass valve 142 open, charge air flows from the third duct 139 through the first cooler bypass duct 141, the cooler bypass valve 142, and the second cooler bypass duct 143, into the fourth duct 149 via the cooler bypass junction 144. At the cooler bypass junction 144, the charge air from the second cooler bypass duct 143 may mix with charge air from the second charge air cooler outlet 140b.

FIG. 5 shows a simulated plot of a possible relationship between charge air temperature and engine speed for a forced induction internal combustion engine including the charge air control system 100 operating the fourth bypass mode. As the measured charge air temperature in the intake manifold 1000 drops below the target temperature, the control unit 160 may instruct the cooler bypass valve 142 to open. Subsequently, at intake junction 144, warmer charge air exiting the second compressor outlet 130b may mix with cooler charge air exiting the second charge air cooler outlet 140b, increasing the temperature of the charge air entering the second turbine inlet 150a. Consequently, the charge air temperature in the intake manifold 1000 may be controlled to meet the target optimum operating temperature.

In a fifth bypass mode, the control system 160 sends a signal via the fifth control loop 165 instructing the turbine bypass valve 152 to switch from a closed position to an open position. With the turbine bypass valve 152 open, charge air flows from the fourth duct 149 through the first turbine bypass duct 151, the turbine bypass valve 152, and the second turbine bypass duct 153, into intake manifold 1000 via the turbine bypass junction 154. At the turbine bypass junction 154, the charge air from the second turbine bypass duct 153 may mix with charge air from the second turbine outlet 150b before entering the air inlet 12a.

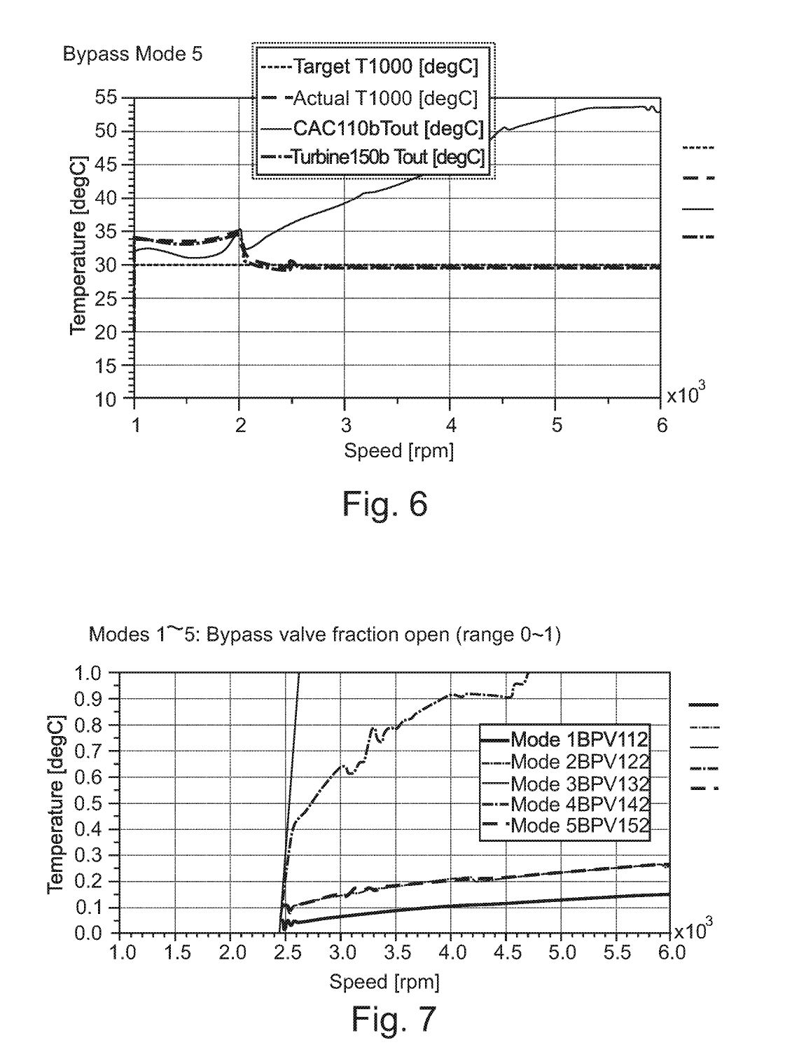

FIG. 6 shows a simulated plot of a possible relationship between charge air temperature and engine speed for a forced induction internal combustion engine including the charge air control system 100 operating the fifth bypass mode. As the measured charge air temperature in the intake manifold 1000 drops below the target temperature, the control unit 160 may instruct the turbine bypass valve 152 to open. Subsequently, at intake junction 154, warmer charge air exiting the second charge air cooler outlet 140b may mix with cooler charge air exiting the second turbine outlet 150b. Consequently, the charge air temperature in the intake manifold 1000 may be controlled to meet the target optimum operating temperature.

Indeed, the modes discussed above may be used in any combination such that one, some, or all of the valves may be closed, partially open or fully open at any particular time.

The charge air control system 100 provides a means of controlling intake charge air temperature over a wide range of ambient air temperatures. When cooling charge air, the charge air control system 100 may advantageously provide the air inlet 12a of the engine 12 with a charge air at a lower temperature than the air exiting the first charge air cooler 110, but with the same mass flow rate. Providing charge air at a lower temperature advantageously reduces combustion knock tendency and reduces production of NO in diesel combustion. Further, a lower charge air temperature may advantageously improve engine performance and fuel economy. In prior art forced induction internal combustion engines including a turbo-expander but without a charge air control system, the temperature of charge air within the intake manifold may be significantly below the optimum operating temperature at certain ambient conditions and engine operating speeds. Advantageously, the charge air control system 100 may control charge air temperature within the intake manifold 1000 to an optimum temperature for efficient engine operation across a wide range of ambient conditions and engine speeds.

In certain embodiments, the first or second charge air cooler may include both a cooling transfer fluid and a heating transfer fluid. The charge air cooler may be configured such that the control unit controls which of the cooling and heating transfer fluid to circulate through the first charge air cooler. Such embodiments may have a heating mode, whereby the control system 160 sends a signal via the sixth control loop 166 instructing the second charge air cooler 140 to circulate a the heating transfer fluid for transferring heat to the charge air.

When heating charge air, the charge air control system 100 may advantageously provide the air inlet 12a of the engine 12 with a charge air at a higher temperature than the air exiting the first charge air cooler 110, but with the same mass flow rate. In certain circumstances, it may be advantageous to raise the temperature of charge air exiting the first cooler 110. A system incapable of controlling charge air temperature would otherwise not be able to provide such an advantage.

In certain embodiments, the first and second charge air coolers described above may be either air-to-air or air-to-liquid charge air coolers. Indeed, any suitable heat exchanger may be used in place of a charge air cooler.

In certain embodiments, the heating transfer fluid of an air-to-liquid charge air cooler may be engine coolant. Typically, engine coolant is controlled by an engine thermostat to be between 80 and 90° C., therefore engine coolant is useful as a heating transfer fluid.

In certain embodiments, the liquid used in the charge air cooler to extract heat from the charge air is cooled using ambient air.

In certain embodiments, the second compressor 130 may be a radial compressor.

In certain embodiments, the second turbine 150 may be a radial turbine.

In certain embodiments, the charge air control system 100 may include a humidity sensor configured to measure humidity of charge air prior to inlet 12a of the forced induction internal combustion engine 10. The control system 160 may receive data relating to humidity from the humidity sensor, and operate the charge air control system 100 in dependence thereon to control the humidity of the charge air prior to the inlet 12a. It is known that combustion can be enhanced by water addition, thus if the second turbine 150 is operated at condensation conditions, the humidity of the charge air entering the engine 10 is increased. Such increased humidity may advantageously improve combustion stability within the engine 10.

In certain embodiments, the second shaft 125 of the turbo-expander 120 may include an electric motor-generator configured to provide power addition to the engine 10 or supplemented power to the second turbine 150 of the turbo-expander 120.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A charge air control system for a forced induction internal combustion engine, comprising:
sensing means arranged to measure one or more attributes of charge air proximal to an air inlet of the internal combustion engine;
comparison means arranged to compare the one or more attributes of charge air to at least one predetermined value; and
temperature control means arranged to control the temperature of the charge air in dependence on the comparison means; wherein the temperature control means comprises:
a turbo-expander having a turbine driving a compressor, configured such that, in use, charge air is compressed in the compressor and then expanded in the turbine, and the turbine outlet is in fluid communication with the air inlet of the internal combustion engine; and
one or more ducts having a valve configured to redirect charge air when the valve is switched between a closed and an open position.

2. The charge air control system of claim 1, wherein the temperature control means further includes at least one heat exchanger configured to transfer heat between the charge air and a control fluid of the heat exchanger.

3. The charge air control system of claim 2, wherein the at least one heat exchanger includes a first heat exchanger positioned between the compressor of the turbo-expander and the turbine of the turbo-expander.

4. The charge air control system of claim 2, wherein the at least one heat exchanger includes a second heat exchanger positioned upstream of the compressor of the turbo-expander.

5. The charge air control system of claim 1, wherein the one or more ducts includes a recirculation duct having a recirculation valve configured to recirculate charge air from an outlet of the compressor of the turbo-expander, to an inlet of the compressor of the turbo-expander.

6. The charge air control system of claim 1, wherein the one or more ducts includes a first bypass duct having a first bypass valve configured for charge air to bypass the turbine of the turbo-expander.

7. The charge air control system of claim 3, wherein the one or more ducts includes a second bypass duct having a second bypass valve configured for charge air to bypass the first heat exchanger.

8. The charge air control system of claim 1, wherein the one or more ducts includes a third bypass duct having a third bypass valve configured for charge air to bypass the turbo-expander.

9. The charge air control system of claim 4, wherein the one or more ducts includes a fourth bypass duct having a fourth bypass valve configured for charge air to bypass the second heat exchanger and the turbo-expander.

10. The charge air control system of claim 1, wherein the temperature control means further includes a control unit configured to receive data relating to an output from the comparison means.

11. The charge air control system of claim 10, wherein the control unit is configured to control the operation of the valve of the one or more ducts in dependence on the output from the comparison means.

12. The charge air control system of claim 3, wherein the first heat exchanger includes a first transfer fluid configured to extract heat from charge air passing therethrough, and further includes a second transfer fluid configured to transfer heat to charge air passing therethrough, wherein the control unit is configured to determine which of the first or second transfer fluids to circulate within the first heat exchanger in dependence on the output from the comparison means.

13. (canceled)

14. (canceled)

15. (canceled)

16. (canceled)

17. (canceled)

18. (canceled)

19. (canceled)

20. A method of controlling the temperature of charge air within a forced induction internal combustion engine comprising:
measuring one or more attributes of charge air proximal to an air inlet of the forced induction internal combustion engine;
comparing each of the one or more measured attributes to at least one predetermined value; and
controlling the temperature of charge air based on a result of the comparison, wherein the controlling the temperature of the charge air comprises:
compressing charge air in a compressor and expanding the compressed charge air in a turbine, wherein an outlet of the turbine is in fluid communication with an air inlet of the internal combustion engine; and
redirecting charge air.

21. (canceled)

22. (canceled)

23. (canceled)

24. The method of claim 20, wherein the predetermined value is a target temperature for charge air prior to intake.

25. The method of claim 20, wherein the forced induction internal combustion engine comprises a turbocharger, a turbo-expander comprising the compressor and the turbine having a first heat exchanger positioned between the compressor and the turbine, and a second heat exchanger positioned between the turbocharger and the turbo-expander.

26. The method of claim 25, wherein the step of controlling comprises controlling whether to circulate a heating or cooling fluid within the first heat exchanger.

27. The method of claim 25, wherein the step of controlling comprises bypassing charge air around the second heat exchanger.

28. The method of any one of claim 25, wherein the step of controlling comprises bypassing charge air around the turbo-expander.

29. The method of claim 25, wherein the step of controlling comprises recirculating charge air from an outlet of the compressor of the turbo-expander to an inlet of the compressor of the turbo-expander.

30. The method of claim 25, wherein the step of controlling comprises bypassing charge air around the first heat exchanger; and/or wherein the step of controlling comprises bypassing charge air around the turbine of the turbo-expander.

31. (canceled)

32. (canceled)

33. (canceled)
